(19) United States
(12) Patent Application Publication
(10) Pub. No.: US 2005/0248114 A1
(43) Pub. Date: Nov. 10, 2005

(54) Vehicle sub-frame connection assembly

(76) Inventors: Frank F. Winkler, Scotts, MI (US); Gary Winkler, Three Rivers, MI (US)

Correspondence Address: ASHKAN NAJAFI, P.A., 6817 SOUTHPOINT PARKWAY, SUITE 2301, JACKSONVILLE, FL, 32216, US

(21) Appl. No.: 10/842,381

(22) Filed: May 10, 2004

(51) Int. Cl. B62D 21/11

(52) U.S. Cl. 280/124.109

(57) ABSTRACT

A vehicle sub-frame assembly for supporting an after-market body part includes support members each provided with a recessed portion for receiving side exhaust pipes therethrough and directing same outwardly from the vehicle sub-frame. The present invention further includes a plurality of plates for securing the support members to the vehicle sub-frame. A cross-brace tube maintains space between the support members and a plurality of caps maintain the cross-brace tube in position during operating conditions. Rear-frame spring-perch tube connectors cooperate with the plurality of caps to fasten the cross-brace tube adjacent the support members. The present invention further includes connectors, each secured to the support members and extending rearwardly for receiving the cross-brace tube.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to vehicle sub-frame assemblies and, more particularly, to a vehicle sub-frame assembly for maintaining exhaust pipes subjacent a unibody vehicle sub-frame during operating conditions.

2. Prior Art

It has been previously known to mount a sub-frame on a vehicle body via resilient bushes, and to pivotally attach the inner ends of the lower arms of a wheel suspension system to the sub-frame. The sub-frame typically comprises a pair of laterally spaced longitudinal members, and a plurality of lateral members passed across the longitudinal members. The longitudinal members and the lateral members are normally made by stamp forming sheet metal, and each member is typically provided with a closed cross section to the end of ensuring sufficient rigidity. Typically, the lower arms of the suspension system are pivotally supported by bearing portions provided in one of the lateral members, and the lateral loads applied by the lower arms of the suspension system are therefore primarily supported by the lateral member.

It is further known in the prior art to provide a vehicle sub-frame, which carries various components of the vehicle, such as steering and suspension components, and is arranged to deform on impact to absorb energy thereby helping to protect occupants of the vehicle in the event of a crash. However the structures disclosed in the prior art do not maximize the ability of the sub-frame to contribute to effective energy absorption.

Double wishbone type suspension is commonly used. In this type of suspension, each of the upper and lower control arms is generally pivotally connected at one end to a sub-frame constituting a rear cross member. However, the sub-frame cannot be formed into a one-piece construction without being formed into an extremely complicated configuration in order to avoid interference between the sub-frame and a differential unit and to assuredly maintain suitable camber of the rear wheels.

Accordingly, a need remains for a vehicle sub-frame assembly that has a simple construction for allowing a user to install an exhaust pipe and to overcome the above-noted shortcomings.

### BRIEF SUMMARY OF THE INVENTION

In view of the foregoing background, it is therefore an object of the present invention to provide vehicle connection assembly for unibody vehicle sub-frames. These and other objects, features, and advantages of the invention are provided by a vehicle sub-frame assembly mountable to a select portion of a vehicle for securely supporting an after-market body part thereto.

Such an assembly includes a plurality of elongated support members having distal and proximal end portions disposed subjacent a unibody vehicle sub-frame. The plurality of support members are oppositely spaced from the axis and extend substantially parallel thereto, generally medially of the vehicle's front and rear axles. Furthermore, the plurality of support members each have a notch formed at the distal end portions thereof for receiving the plurality of connectors (described herein below), respectively. Such a plurality of support members are preferably formed from aluminum, but may be formed from other suitable material, well-known to a person of ordinary skill in the art.

Advantageously, each of the plurality of support members has a recessed portion formed therein and is spaced substantially medially of the proximal and distal end portions so that a plurality of corresponding side exhaust pipes can be guided and supported outwardly from the vehicle sub-frame respectively. Such a plurality of recesses may have substantially arcuate shapes and are preferably aligned along a parallel plane so that a plurality of corresponding side exhaust pipes may be maintained at symmetrically opposed sides of the vehicle sub-frame.

The present invention further includes a plurality of plates for securing the plurality of support members to the vehicle sub-frame. An elongated cross-brace tube extends substantially perpendicular to the axis for assisting to maintain a select spatial relationship between the plurality of support members. Such a cross-brace tube is disposed substantially medially of the distal end portions of the plurality of support members is preferably formed from steel or other suitable materials, well-known in the industry.

The present invention further includes a plurality of caps with arcuate end portions for receiving and maintaining the cross-brace tube at a substantially stable position. A plurality of rear-frame spring-perch tube connectors are disposed above the cross-brace tube for cooperating with the plurality of caps to securely fasten the cross-brace tube adjacent the plurality of support members.

The present invention further includes a plurality of connectors each provided with a first portion secured to the plurality of support members and further provided with a second portion extending rearwardly therefrom for receiving a select portion of the cross-brace tube therein respectively.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a top plan view showing a vehicle sub-frame connection assembly for connecting a plurality of exhaust pipes subjacent a vehicle, in accordance with the present invention; and

FIG. 2 is an exploded perspective view of the present invention shown in FIG. 1.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

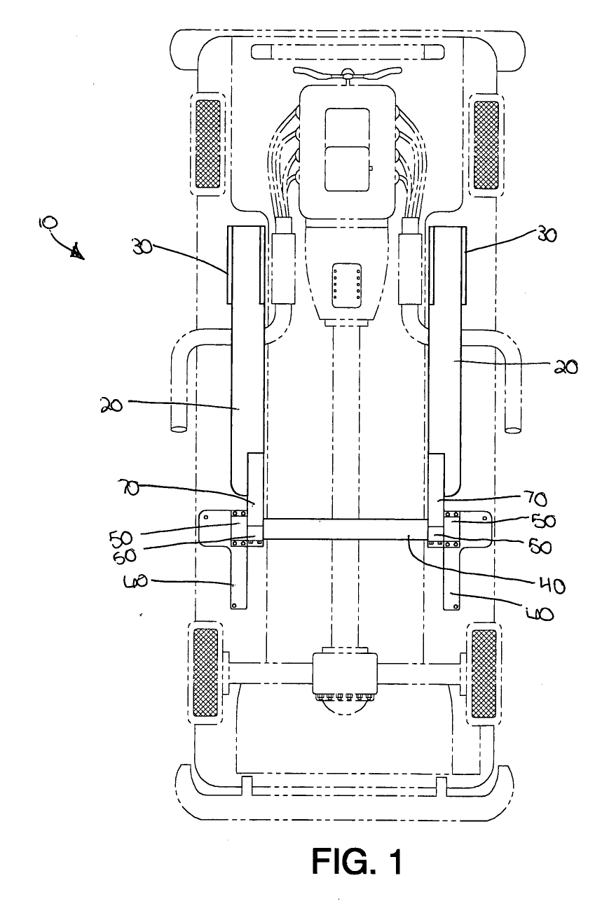

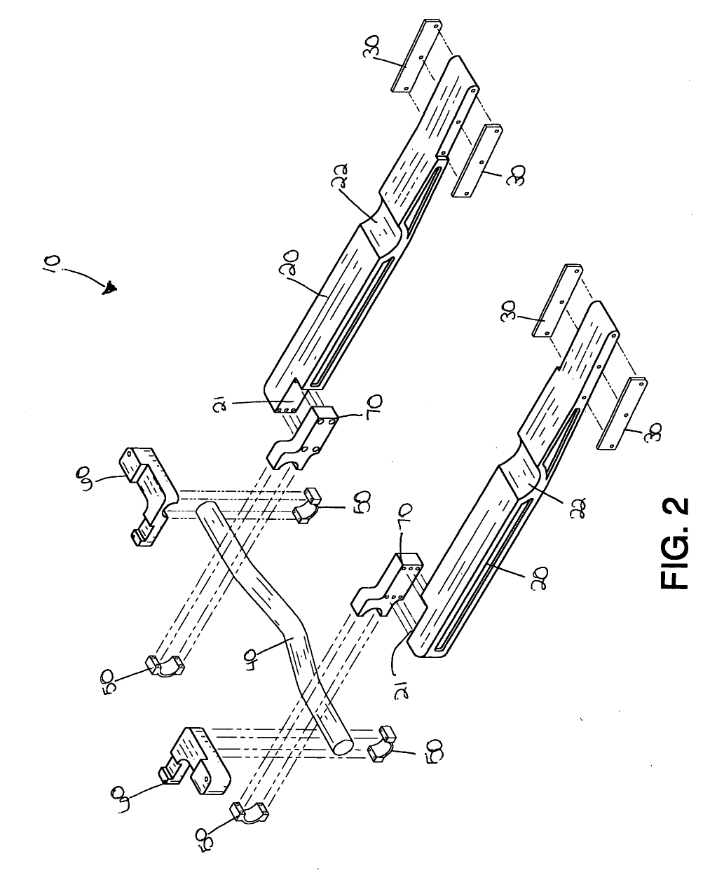

The assembly of this invention is referred to generally in FIGS. 1 and 2 by the reference numeral 10 and is intended to allow a user to securely connect exhaust pipes subjacent a vehicle body. It should be understood that the assembly 10 may be used secure a variety of after-market body exhaust pipes to a unibody vehicle sub-frame.

Referring initially to FIG. 2, the assembly 10 includes a plurality of elongated support members 20 having distal and proximal end portions disposed subjacent a unibody vehicle sub-frame. The plurality of support members 20 are oppositely spaced from the axis and extend substantially parallel thereto, generally medially of the vehicle's front and rear axles. Furthermore, the plurality of support members 20 each have a notch 21 formed at the distal end portions thereof for receiving the plurality of connectors (described herein below), respectively. Such a plurality of support members 20 are preferably formed from aluminum, but may be formed from other suitable material, well-known to a person of ordinary skill in the art.

Advantageously, each of the plurality of support members 20 has a recessed portion 22 formed therein and is spaced substantially medially of the proximal and distal end portions so that a plurality of corresponding side exhaust pipes can be guided and supported outwardly from the vehicle sub-frame respectively. Such a plurality of recesses 22 may have substantially arcuate shapes and are preferably aligned along a parallel plane so that a plurality of corresponding side exhaust pipes may be maintained at symmetrically opposed sides of the vehicle sub-frame. Accordingly, the side exhaust pipes may be securely maintained beneath the vehicle while maintaining proper ground clearance.

The present invention further includes a plurality of plates 30 for securing the plurality of support members 20 to the vehicle sub-frame. An elongated cross-brace tube 40 extends substantially perpendicular to the axis for assisting to maintain a select spatial relationship between the plurality of support members 20. Such a cross-brace tube 30 is disposed substantially medially of the distal end portions of the plurality of support members 20 and is preferably formed from steel or other suitable materials, well-known in the industry.

The present invention further includes a plurality of caps 50 with arcuate end portions for receiving and maintaining the cross-brace tube 40 at a substantially stable position. A plurality of rear-frame spring-perch tube connectors 60 are disposed above the cross-brace tube 40 for cooperating with the plurality of caps 50 to securely fasten the cross-brace tube 40 adjacent the plurality of support members 20.

The present invention further includes a plurality of connectors 70 each provided with a first portion secured to the plurality of support members 20 and further provided with a second portion extending rearwardly therefrom for receiving a select portion of the cross-brace tube 40 therein respectively.

The increased rigidity of the present invention will eliminate unwanted flexing commonly found in all unibody sub-frame cars, thereby providing improved handling, cornering, braking, and acceleration. The present invention also appeals to vehicle-customizing enthusiasts who want to install side exhaust pipes.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A vehicle sub-frame assembly mountable to a select portion of a vehicle having a centrally disposed longitudinal axis and for securely supporting an after-market body part to the vehicle, said assembly comprising:
a plurality of elongated support members having distal and proximal end portions disposed subjacent a unibody vehicle sub-frame, said plurality of support members being oppositely spaced from the axis and extending substantially parallel thereto generally medially of the vehicle's front and rear axles, each said plurality of support members having a recessed portion formed therein and being spaced substantially medially of said proximal and distal end portions so that a plurality of corresponding side exhaust pipes can be guided and supporting outwardly from the vehicle sub-frame respectively;
a plurality of plates for securing said plurality of support members to the vehicle sub-frame;
an elongated cross-brace tube extending substantially perpendicularly to the axis and for assisting to maintain a select spatial relationship between said plurality of support members;
a plurality of caps having arcuate end portions for receiving and maintaining said cross-brace tube at a substantially stable position;
a plurality of rear-frame spring-perch tube connectors disposed above said cross-brace tube and for cooperating with said plurality of caps to securely fasten said cross-brace tube adjacent said plurality of support members; and
a plurality of connectors each having a first portion secured to said plurality of support members and a second portion extending rearwardly therefrom and for receiving a select portion of said cross-brace tube therein respectively.

2. The vehicle sub-frame assembly of claim 1, wherein said cross-brace tube is disposed substantially medially of said distal end portions of said plurality of support members.

3. The sub-frame vehicle assembly of claim 1, wherein said plurality of support members each have a notch formed at said distal end portions thereof and for receiving said plurality of connectors respectively.

4. The sub-frame vehicle assembly of claim 1, wherein the plurality of recesses have substantially arcuate shapes and are aligned along a parallel plane so that a plurality of corresponding side exhaust pipes can be maintained at symmetrically opposed sides of the vehicle sub-frame.

5. The sub-frame vehicle assembly of claim 1, wherein said cross-brace tube is formed from steel.

6. The sub-frame vehicle assembly of claim 1, wherein said plurality of support members are formed from aluminum.

7. A vehicle sub-frame assembly mountable to a select portion of a vehicle having a centrally disposed longitudinal axis and for securely supporting an after-market body part to the vehicle, said assembly comprising:
a plurality of elongated support members having distal and proximal end portions disposed subjacent a unibody vehicle sub-frame, said plurality of support members being oppositely spaced from the axis and extending substantially parallel thereto generally medially of the vehicle's front and rear axles, each said plurality of support members having a recessed portion formed therein and being spaced substantially medially of said proximal and distal end portions so that a plurality of corresponding side exhaust pipes can be guided and supporting outwardly from the vehicle sub-frame respectively;
a plurality of plates for securing said plurality of support members to the vehicle sub-frame;
an elongated cross-brace tube formed from steel and extending substantially perpendicularly to the axis and for assisting to maintain a select spatial relationship between said plurality of support members;
a plurality of caps having arcuate end portions for receiving and maintaining said cross-brace tube at a substantially stable position;
a plurality of rear-frame spring-perch tube connectors disposed above said cross-brace tube and for cooperating with said plurality of caps to securely fasten said cross-brace tube adjacent said plurality of support members; and
a plurality of connectors each having a first portion secured to said plurality of support members and a second portion extending rearwardly therefrom and for receiving a select portion of said cross-brace tube therein respectively.

8. The vehicle sub-frame assembly of claim 7, wherein said cross-brace tube is disposed substantially medially of said distal end portions of said plurality of support members.

9. The sub-frame vehicle assembly of claim 7, wherein said plurality of support members each have a notch formed at said distal end portions thereof and for receiving said plurality of connectors respectively.

10. The sub-frame vehicle assembly of claim 7, wherein the plurality of recesses have substantially arcuate shapes and are aligned along a parallel plane so that a plurality of corresponding side exhaust pipes can be maintained at symmetrically opposed sides of the vehicle sub-frame.

11. The sub-frame vehicle assembly of claim 7, wherein said plurality of support members are formed from aluminum.

12. A vehicle sub-frame assembly mountable to a select portion of a vehicle having a centrally disposed longitudinal axis and for securely supporting an after-market body part to the vehicle, said assembly comprising:
a plurality of elongated support members formed from aluminum and having distal and proximal end portions disposed subjacent a unibody vehicle sub-frame, said plurality of support members being oppositely spaced from the axis and extending substantially parallel thereto generally medially of the vehicle's front and rear axles, each said plurality of support members having a recessed portion formed therein and being spaced substantially medially of said proximal and distal end portions so that a plurality of corresponding side exhaust pipes can be guided and supporting outwardly from the vehicle sub-frame respectively;
a plurality of plates for securing said plurality of support members to the vehicle sub-frame;
an elongated cross-brace tube formed from steel and extending substantially perpendicularly to the axis and for assisting to maintain a select spatial relationship between said plurality of support members;
a plurality of caps having arcuate end portions for receiving and maintaining said cross-brace tube at a substantially stable position;
a plurality of rear-frame spring-perch tube connectors disposed above said cross-brace tube and for cooperating with said plurality of caps to securely fasten said cross-brace tube adjacent said plurality of support members; and
a plurality of connectors each having a first portion secured to said plurality of support members and a second portion extending rearwardly therefrom and for receiving a select portion of said cross-brace tube therein respectively.

13. The vehicle sub-frame assembly of claim 12, wherein said cross-brace tube is disposed substantially medially of said distal end portions of said plurality of support members.

14. The sub-frame vehicle assembly of claim 12, wherein said plurality of support members each have a notch formed at said distal end portions thereof and for receiving said plurality of connectors respectively.

15. The sub-frame vehicle assembly of claim 12, wherein the plurality of recesses have substantially arcuate shapes and are aligned along a parallel plane so that a plurality of corresponding side exhaust pipes can be maintained at symmetrically opposed sides of the vehicle sub-frame.
